(19) United States
(12) Patent Application Publication
(10) Pub. No.: US 2025/0035019 A1
(43) Pub. Date: Jan. 30, 2025

(54) Sensor determinate oil life reporting and alert system

(71) Applicant: Terry Lee Torres, Neptune, NJ (US)

(72) Inventor: Terry Lee Torres, Neptune, NJ (US)

(21) Appl. No.: 18/226,668

(22) Filed: Jul. 26, 2023

(51) Int. Cl. F01M 11/12; G07C 5/00; G07C 5/08

(52) U.S. Cl. CPC F01M 11/12; G07C 5/006; G07C 5/008; G07C 5/0808; F01M 2011/14

(57) ABSTRACT

The present invention introduces a groundbreaking technology for precise and real-time monitoring of engine/transmission oil, revolutionizing the automotive industry's maintenance practices. Utilizing an optional array of sensors, including Turbidity, Magnet Inductance, Conductivity, Permittivity, Chemiresistors, and ChemFETs, the system continuously assesses the oil's state, providing users with invaluable insights into its health and condition. By eliminating guesswork and manufacturer-recommended schedules, the invention empowers users to make informed decisions about oil changes, extending engine/transmission lifespan and optimizing operational lubricity.

The technology's key benefits include improved gas mileage, cost savings on fuel, and enhanced protection against premature power train failure. The invention also offers a unique advantage by recording and graphing changes in oil lubricity between oil changes, aiding in the early detection of engine/transmission problems. Moreover, the incorporation of chemical sensors allows the detection of newly created breakdown chemicals, unburned petrol, and antifreeze accumulation, further safeguarding against potential issues and expensive parts failures.

The system's implementation includes a user-friendly dipstick embodiment, featuring an electronic enclosure housing sensors and a microcontroller. Upon reinsertion into the dipstick tube, the dipstick performs a series of tests to determine oil level and clarity, storing baseline measurements in nonvolatile memory. A low-power Bluetooth module enables seamless data transmission to the user's cell phone app, providing access to recorded test results, graphs, and timely oil status alerts.

Additionally, an advanced version of the technology contemplates continuous oil sampling during vehicle operation through a “test sample isolation chamber.” This innovative concept allows for comprehensive monitoring of the engine/transmission oil, offering a comprehensive analysis of the oil's health in real-world conditions.

In conclusion, the present invention represents a game-changing advancement in automotive maintenance, offering unparalleled accuracy, improved engine/transmission health, and cost-effective oil management. By integrating cutting-edge sensors and intelligent data processing, this technology empowers users to make data-driven decisions, ensuring optimal engine/transmission performance and prolonging the lifespan of these vital systems.

### BACKGROUND OF THE INVENTION

### Field of the Invention

In the current state of the automotive industry, conventional engine/transmission dipsticks are utilized to measure oil volume and enable visual inspection of oil clarity (turbidity). The level to which the oil wets the dipstick scale indicates the system's fullness, while the optical oil clarity (turbidity) serves as an indicator of the oil's condition.

However, it is essential to acknowledge that the existing practices in the automotive manufacturing and maintenance sectors for oil replacement are primarily based on estimations rather than scientific data. Although specific instructions are provided with new automobiles regarding oil change intervals, these guidelines lack scientific support throughout the vehicle's lifespan. The rate of oil contamination in a vehicle is closely related to the age and health of its engine/transmission. As the vehicle ages and experiences wear, the rate of oil contamination increases. Consequently, the oil requires more frequent changes to maintain optimal operational lubricity.

Moreover, various driving styles can also influence the breakdown of oil and its contamination rate. Aggressive driving accelerates the oil's degradation, necessitating more frequent oil changes compared to a non-aggressive driving style.

Furthermore, as the serviceable life of oil approaches its end, it undergoes chemical breakdown. This breakdown leads to significant changes in the oil's lubricating properties. Although the market offers diverse types of oil with varying compositions, a common aspect among all oils is that they break down and generate new chemical components and molecules that were not initially present in the pristine base oil.

In light of these challenges, there exists a need for a more scientific approach to determine the appropriate intervals for oil changes based on the specific conditions and characteristics of the vehicle and its usage patterns. By addressing these concerns, the present invention aims to provide an improved system for optimizing oil change schedules, enhancing vehicle performance, and prolonging the overall longevity of the engine and transmission systems.

### BRIEF SUMMARY OF THE INVENTION

The current patent application pertains to an innovative electronic system that offers precise determination of optimal fullness and breakdown contaminate levels for engine/transmission oil. Acknowledging the considerable variations in the breakdown rate and true lifespan of engine/transmission oil, this technology revolutionizes the way users/drivers are informed about the actual need for oil changes and top-offs in real-time.

Unlike existing methods that rely on estimations and generic manufacturer-recommended oil change schedules, the present invention eliminates guesswork. It introduces a groundbreaking technology that continually and accurately informs users about the condition of their oil, providing real-time alerts based on the oil's quality and its ongoing state of breakdown throughout its service life.

By deploying this electronic means, vehicle owners can make informed decisions about the precise timing of oil changes, enhancing the efficiency and performance of their engines and transmissions. This technology represents a significant advancement in the automotive industry, as it empowers users to optimize their maintenance practices, thereby extending the longevity of their engine/transmission systems and ensuring optimal operational lubricity. The present invention is poised to set a new standard for intelligent and data-driven oil management in the automotive sector.

### BRIEF DESCRIPTION OF THE DRAWINGS

FIG. 1: presents a comprehensive block diagram illustrating the flow chart of the invention's components and their configurations. Regardless of the specific physical embodiment of the technology, one or more of the following configuration descriptions will be implemented.

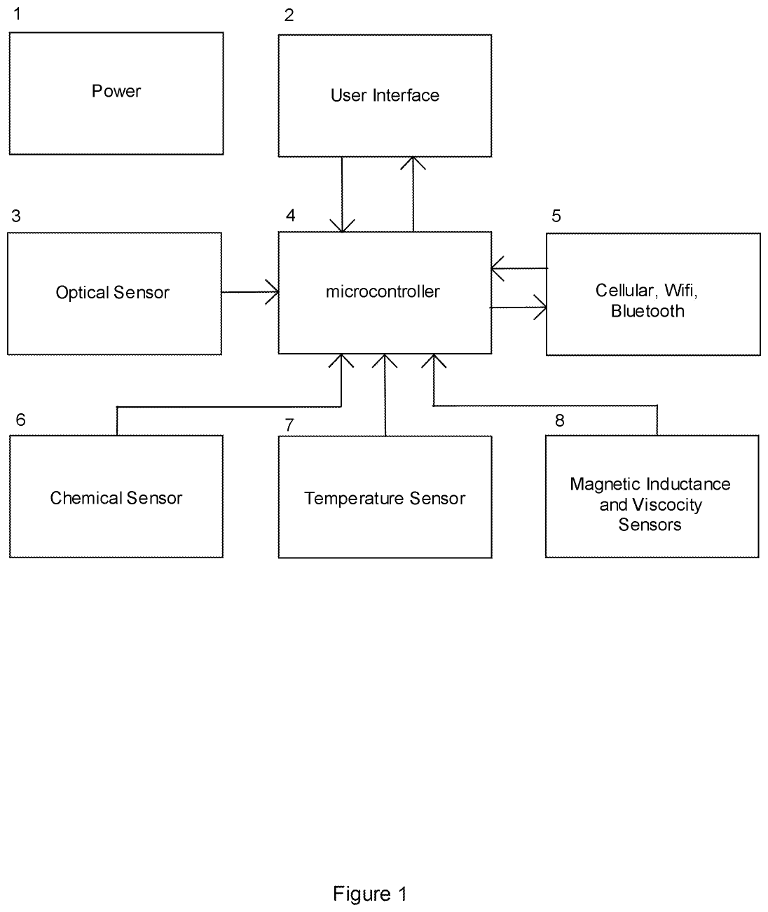

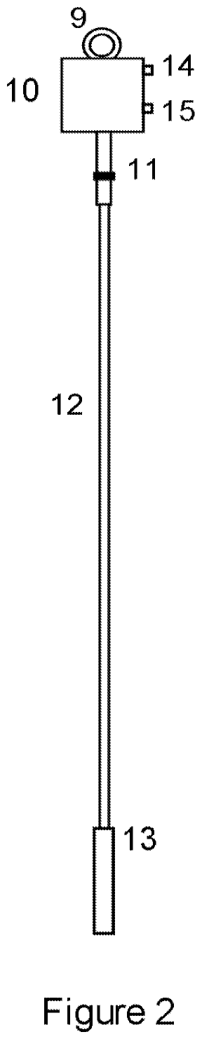

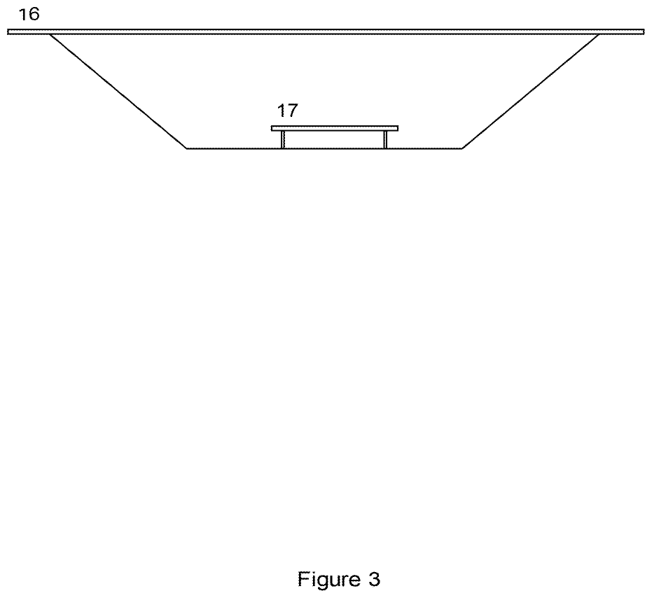

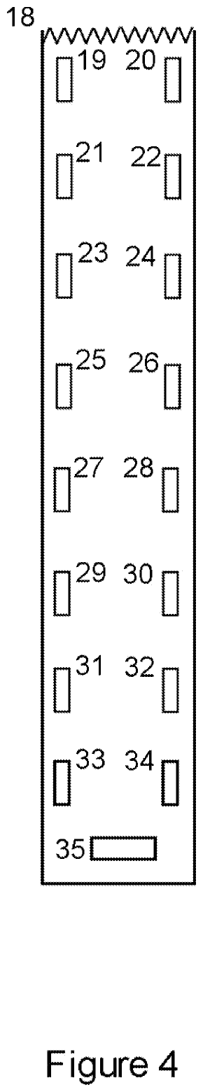

Item 1 in FIG. 1 represents the power supply unit of the invention. Although not explicitly shown in FIG. 1, Item 1 supplies power to all the other components listed in this diagram. The power supply can be as straightforward as a series of batteries for self-contained portable use or can be integrated into the power system of the available engine/transmission system, depending on the technology's specific implementation.

Item 2 in FIG. 1 denotes the user interface unit of the invention. This interface includes optional indicators such as LEDs, warning buzzers, speakers, and liquid crystal displays (LCDs). It may also encompass various controls like push buttons, switches, and/or touch screen capabilities. The user interface is responsible for generating warning signals, battery status information, visual and pictorial graphs, written text, and audio signals, including beeping sounds and playback of pre-recorded human speech. These signals accurately represent the current state of the oil's quality and volume in real-time. Item 2 in FIG. 1 may also include integration of A.I. direct analysis, control and reporting systems such as those previously described above.

Item 3 in FIG. 1 represents the optical sensor unit. Utilizing visible or invisible light emitting and detecting sensors, this unit continuously determines the clarity of the engine/transmission oil throughout its life cycle.

Item 4 in FIG. 1 signifies the microcontroller unit, which serves as the control and decision-making component of the present invention. It interfaces with all other control and sensing components listed in FIG. 1. This microcontroller processes all sensor data, provides user signaling, and orchestrates external communications with the system. Additionally, Item 4 incorporates nonvolatile memory for data storage.

Item 5 in FIG. 1 represents the cellular, WiFi, and Bluetooth modules that facilitate external communications. This unit enables remote signaling of the system's current status and accepts commands to update, modify, or deactivate active alert notifications or other system parameters. In addition, this unit may also allow for interface, control and analysis processes directed by local or remote A.I. means.

Item 6 in FIG. 1 denotes the chemical sensor unit (Chemiresistors, or ChemFETs). This sensor is designed to detect the new chemicals generated by the breakdown of the base oil. As different oils produce a wide variety of breakdown chemicals, the appropriate chemical sensor will be selected to detect the most relevant breakdown chemical based on volumetric ratio to the base oil. Over the lifespan of the oil, the presence of this breakdown chemical will gradually increase. Item 6 detects the increase and provides a signal directly proportional to the magnitude of the breakdown chemical.

Item 7 in FIG. 1 represents the temperature sensor unit, which simply monitors the temperature of the oil.

Item 8 in FIG. 1 signifies the magnetic inductance sensor unit, an optional sensor applicable to engines/transmissions made with a heavy iron composition. This sensor detects variations in inductance, which increase correspondingly with the amount of iron present in the oil. Consequently, it provides an indication of the oil's contamination level, as a higher concentration of iron implies greater oil contamination. Additionally, Item 8 also includes a viscosity sensor. A micro dc motor driving miniature paddles.

FIG. 2: showcases a representative oil dipstick that incorporates an optional configuration, comprising items 1 through 5 and item 7 from FIG. 1. It should be noted that items 6 and 8 from FIG. 1 can also be incorporated with the appropriate development of these sensors.

Item 9 in FIG. 2 refers to the dipstick's loop handle, allowing convenient extraction, handling, and reinsertion of the dipstick.

Item 10 in FIG. 2 represents the dipstick's electronic enclosure housing items 1, 2, 4, 5, and 7 from FIG. 1.

Item 11 in FIG. 2 denotes the dipstick's O-ring seal, which prevents oil from being ejected through the dipstick tube.

Item 12 in FIG. 2 is the dipstick's probe lead, comprising a fiberglass circuit board with electrical wire traces running along its entire length. This component facilitates the interface between the electronics housed in item 10 and the surface-mounted components located at the dipstick's probe tip, item 13. Nevertheless, it should be noted that any multiple conductor wire may also be bound together through a semi rigid structure allowing for the uninterrupted insertion and extraction of the probe tip, item 13, into the dipstick engine/transmission guide tubing. This may be inclusive of fiber optic cable to serve as a communications channel from the dipstick's probe tip, item 13, to the electronics housed in Item 10.

Item 13 in FIG. 2 constitutes a fiberglass circuit board containing sets of optical emitters and detectors described in FIG. 1, item 3. Optionally it may also contain any of the sensors described in this document. These high-temperature emitters and detectors can withstand the engine's oil temperatures. Additionally, item 13 incorporates a temperature sensor 7 to monitor the oil temperature.

Item 14 in FIG. 2 serves as the on/off switch for the unit.

Item 15 in FIG. 2 represents the push-button programming switch for the unit.

FIG. 3: presents a cutaway view of a conventional oil pan and/or transmission oil pan equipped with the array of sensors described in the present invention.

Item 16 in FIG. 3 depicts a cutaway view of any conventional engine or transmission oil pan.

Item 17 in FIG. 3 illustrates the plethora of sensors described within the present invention. Although not explicitly shown in FIG. 3, the circuit board-mounted sensors can be externally connected to circuitry outside the engine or transmission pan through an appropriate hole and sealing grommet, enabling a cable to exit the associated oil pan. Alternatively, the circuit board-mounted sensors can be externally connected to circuitry outside the engine or transmission pan via a flat ribbon cable that can pass right between the associated oil pan seal and mating surface.

FIG. 4: provides a magnified view of the sensor tip illustrated in FIG. 2, item 13. This depiction shows a series of LEDs (item numbers 19, 21, 23, 25, 27, 29, 31 and 33) positioned one above the other, along with a series of photo or pin diodes (item numbers 20, 22, 24, 26, 28, 30, 32 and 34). It should be noted that in while only 8 LED and pin diode pair stages have been described here, any number of LED and pin diode pair stages may be used to achieve a particular resolution to meet a desired overall system accuracy.

Item 35 in FIG. 4 represents the unit's oil temperature sensor.

### DETAILED DESCRIPTION OF THE INVENTION

The present invention introduces an advanced system that utilizes a range of optional sensors, including Turbidity, Magnetic Inductance, Conductivity, Permittivity, Viscosity, Chemiresistors, or ChemFETs, to continuously monitor engine/transmission oil and provide users with precise, real-time information about the oil's condition. The primary objective of the invention is to extend the longevity and overall health of engine/transmission systems by ensuring optimal lubricity. This, in turn, leads to improved gas mileage, resulting in cost savings for operators. One of the most effective ways to safeguard power trains from premature failure is through regular and timely oil changes, making this technology a valuable asset.

An unexplored advantage of the present technology is its ability to record and make available to the user a smart phone generated graph that plots changes over time in the oil's lubricity between oil changes. This smart phone generated graph provides valuable insights into the engine/transmission's overall health, allowing for the early detection of any potential problems before they lead to catastrophic failures. Additionally, the smart phone app may allow multiple vehicles to be remotely monitored individually by one person.

To utilize the invention, the user conducts a full oil change to ensure the oil is new and up to nominal operating level. The conventional dipstick that came with the vehicle is then used to top off the engine/transmission oil to the full state.

In reference to FIG. 2, the dipstick is powered on by inserting a battery into a battery holder and toggling the on/off switch 14 contained within FIG. 2.

The dipstick is reinserted into the dipstick tube of the engine/transmission, causing a series of LEDs and photodiodes located at the dipstick's tip 18 to become submerged under the oil.

A programming button 14 is pressed to initialize a learn mode. The LEDs 19, 21, 23, 25, 27, 29, 31 and 33 and pin diode sensors 20, 22, 24, 26, 28, 30, 32 and 34 are configured as matching pairs positioned one above the next along the dipstick's tip 18. They sequentially scan upwards through each set to determine which set is the physically highest set submerged under the oil. This process involves comparing the in-air sensor magnitude detected by the photodiodes with the in-oil sensor magnitude of the submerged sets. The sequential scanning establishes the oil level height, which is stored into nonvolatile memory as the full oil level state.

After the microcontroller determines the oil level height, it conducts an oil clarity (turbidity) measurement. The microcontroller activates the lowest set, LED 33 and pin diode 34, submerged under the oil. The LED 33 emits radiation into the oil, which is detected by the adjacent pin diode 34. The output voltage generated by the pin diode 34 corresponds to the clarity of the oil. This measurement is stored as a baseline value representing the new oil state.

Subsequently, the microcontroller 4 enters a scan mode protocol and powers down.

During vehicle operation, as the oil heats up, the microcontroller 4 generates an interrupt when a specific temperature is reached, setting the microcontroller 4 into standby mode.

When the vehicle is turned off and the oil begins to cool, the microcontroller 4 monitors the declining oil temperature until a defined low temperature is reached. At this point, the microcontroller 4 assumes that all the oil has had enough time to return to the oil pan 16 and initializes an oil wellness test.

The microcontroller 4 begins by conducting an oil level test, comparing the results of the new scan with the recorded baseline measurements. It scans through the sequential LED 19, 21, 23, 25, 27, 29, 31 and 33 and pin diode sets 20, 22, 24, 26, 28, 30, 32 and 34 to determine the oil level height. If the oil level height matches the baseline height, the system records a passing level result. However, if the oil level height is lower than the baseline height, the system records a failing level result.

The microcontroller 4 proceeds to conduct an oil clarity (turbidity) test. It activates the lowest set of LEDs 33 and pin diodes 34 submerged under the oil, and the LED 33 emits radiation into the oil. The resulting output voltage generated by the pin diode 34 corresponds to the clarity measurement, which is compared to the originally recorded baseline clarity measurement. If the new clarity measurement remains within a predetermined threshold of the baseline clarity measurement, a passing result is recorded. If it falls outside the threshold, a failing result is recorded along with the magnitude. Additionally, Magnetic Inductance, Conductivity, Permittivity, Viscosity, Chemiresistors or ChemFETs tests can be performed as desired.

After completing all tests, the system shuts down. However, a low-power Bluetooth module 5 initiates transmission of a repeated signal at a specified rate (Or in high end model units the signal may be transmitted once via cellular link 5). When the user comes within proximity of the dipstick, their cell phone app pairs and syncs with the dipstick's Bluetooth module 5, downloading all test data recorded since the last download.

The cell phone app continuously scans for a valid Bluetooth link to receive incoming data from the dipstick, repeating a continuous series of scans at specified intervals. This app can display data collected over time in the form of graphs, numeric data, or a simplified “go no go” warning image or text. Furthermore, if the dipstick sensor technology determines low oil level, it can transmit an urgent warning signal to the cell phone app, alerting the user via tones, vibration, text message or verbal messages. Similarly, if the oil clarity (turbidity) test indicates a need for an oil change, an urgent warning signal is sent to the cell phone app.

Optionally, a WiFi and/or cellular communication link 5 is provided for communication over nearby networks. This two-way communication link can transmit system status data, alert signals, and accept incoming parameter changes and firmware reprogramming.

Additionally, a preferred embodiment contemplates incorporating all of the sensors described in FIG. 1 as a built-in platform configuration, as illustrated in FIG. 3. In this design, all available sensors are assembled to sit within the oil pan housing 16 or an equally accessible location in any engine/transmission. A dedicated oil analysis and sensor array control module assumes the responsibilities of the previously described microcontroller 4 and can be configured to orchestrate oil level tests and any or all oil quality tests while also communicating the applicable sensed intelligence with the outside world. The dedicated oil analysis and sensor array control module may reside externally or be directly integrated into the engine control module, transmission control module, or body control module circuitry and programming, ideally allowing for integration by the manufacturer. Additionally, the chemical sensors described in FIG. 1, item 6, can be utilized to detect newly created chemicals resulting from the breakdown of the base oil. Petrol sensors can also measure the amount of unburned petrol in the oil, serving as an early indicator of piston blow by conditions. Furthermore, a chemical sensor 6 can detect an accumulation of antifreeze in the oil, indicating a blown head gasket or other seal failures. Detecting these issues at an early stage can save owners money by preventing them from evolving into more expensive parts failures.

Furthermore, the inventor also conceived the concept of sampling the oil while the engine is running, using what is termed a “test sample isolation chamber.” This chamber allows for the continuous sampling of the engine/transmission oil at predefined intervals during normal vehicle operation. A test sample isolation chamber may be as simple as a small cylinder and piston chamber powered by a small motor that draws a small quantity of oil into the chamber using suction produced by the backward movement of the piston, similar to a syringe. The chamber integrates multiple sensors, and the oil clarity (turbidity) can be continuously monitored in defined intervals as described in the invention's other embodiments. The test sample isolation chamber can be mounted directly into the engine/transmission body or be configured externally using a modified dipstick with a narrow tube running its length. The technology enables continuous monitoring of the engine/transmission oil, providing valuable data for analysis and record-keeping as detailed in the previous sections.

In another setup designed to function as an alternative isolation chamber for test samples, there is a submerged cylinder beneath the engine/transmission oil surface. This cylinder houses all the required sensors and has a simple cover that can be easily opened by a solenoid or servo mechanism. This opening allows the natural turbulence of the operating engine/transmission to replace the contents inside the cylinder with a fresh sample. Following this, a solenoid or servo mechanism would then close the cover, effectively sealing the internal volume of oil within the cylinder from the turbulent oil present outside the chamber. Consequently, this sealed volume of oil, isolated from the external turbulence, becomes available for testing using the array of sensors.

While the present invention has been described with reference to certain embodiments, it is essential to recognize that various modifications and applications are possible within the scope of the invention. Therefore, the invention should not be limited to the disclosed embodiments but should encompass the full scope defined by the appended claims.

What is claimed:

1. An oil monitoring system for engine/transmission systems, comprising:
a. A dipstick with optional sensors including Turbidity, Viscosity, Magnetic Inductance, Conductivity, Permittivity, Chemiresistors, or ChemFETs, positioned at the tip, to collect real-time data on oil condition when inserted into the engine/transmission oil;
b. A microcontroller integrated into the dipstick, programmed to determine oil level height and clarity by comparing in-air sensor magnitudes with in-oil sensor magnitudes during the turbidity test and LED/pin diode optical test. It records baseline measurements for subsequent oil tests;
c. A low-power communication module integrated into the dipstick, enabling transmission of oil test data to external devices, including but not limited to smart phones, tablets, computers, or cloud-based platforms;
d. An application software capable of pairing and syncing with the dipstick's communication module, receiving and displaying oil test data in various formats, such as graphs, numeric data, or warning messages. The application further generates urgent warning signals for low oil level and oil clarity issues;
e. An optional remotely located microcontroller housing, programmed to perform oil level and oil clarity tests using in-air and in-oil sensor magnitudes during the turbidity test and LED/pin diode optical test. It connects to the dipstick via electrical or wireless means to receive real-time oil condition data.

2. The oil monitoring system of claim 1, wherein the optional sensors are arranged in matching pairs along the dipstick's tip, scanning sequentially upward to determine the physically highest set submerged under the oil.

3. The oil monitoring system of claim 1, wherein the microcontroller conducts an oil level test by scanning through the sequential sets of optional sensors, comparing the results to recorded baseline measurements, and recording a passing or failing level result based on the comparison.

4. The oil monitoring system of claim 1, wherein the microcontroller conducts an oil clarity test by activating the lowest pair of optical emitter-detector sensors submerged under the oil, comparing the new clarity measurement to the recorded baseline clarity measurement, and recording a passing or failing result based on the comparison.

5. The oil monitoring system of claim 1, further comprising a communication link, including but not limited to WiFi and/or cellular, for transmitting system status data, alert signals, and accepting incoming parameter changes and firmware reprogramming.

6. The oil monitoring system of claim 1, wherein chemical sensors are utilized to detect newly created chemicals resulting from the breakdown of the base oil and to measure the amount of unburned petrol or antifreeze in the oil, serving as an early indicator of piston blow-by conditions or seal failures.

7. A built-in platform configuration of the oil monitoring system of claim 1, wherein some or all optional sensors are assembled within the engine/transmission oil pan housing or an accessible location in any engine/transmission. They are controlled by a dedicated oil analysis and sensor array control module, which orchestrates oil level tests and any or all oil quality tests and communicates the sensed intelligence externally.

8. The built-in platform configuration of claim 7, wherein the dedicated oil analysis and sensor array control module resides externally or is directly integrated into the engine control module, transmission control module, or body control module circuitry and programming.

9. The built-in platform configuration of claim 7, wherein chemical sensors are utilized to detect newly created chemicals resulting from the breakdown of the base oil and to measure the amount of unburned petrol or antifreeze in the oil, serving as an early indicator of piston blow-by conditions or seal failures.

10. A test sample isolation chamber for continuous sampling of engine/transmission oil at predefined intervals during normal vehicle operation, comprising:
a. A small cylinder and piston chamber powered by a small motor, capable of drawing a small quantity of oil into the chamber using suction produced by the backward movement of the piston;
b. Multiple sensors integrated into the chamber to continuously monitor oil clarity and oil level in intervals;
c. The test sample isolation chamber being mounted directly into the engine/transmission body or configured externally using a modified dipstick with a narrow tube running its length, enabling continuous monitoring of engine/transmission oil and providing valuable data for analysis and record-keeping.

11. The test sample isolation chamber of claim 10, wherein the multiple sensors in the chamber include Turbidity, Viscosity, Magnetic Inductance, Conductivity, Permittivity, Chemiresistors, or ChemPETs to measure oil quality, and the chamber is equipped with a low-power communication module, including but not limited to a Bluetooth module or optional WiFi and/or cellular communication link, to transmit oil test data to an external device for data analysis and presentation.
